(19) United States
(12) Patent Application Publication
(10) Pub. No.: US 2003/0024224 A1
(43) Pub. Date: Feb. 6, 2003

(54) Apparatus for cutting vegetation

(76) Inventor: John E. Frank, Bridgenorth (GB)

Correspondence Address: WOOD, PHILLIPS, VAN SANTEN, CLARK & MORTIMER, Suite 3800, 500 West Madison Street, Chicago, IL, 60661-2511, US

(21) Appl. No.: 10/044,663

(22) Filed: Oct. 23, 2001

(30) Foreign Application Priority Data
Jan. 15, 2001 (GB) 0101039.6

(51) Int. Cl. A01D 34/03

(52) U.S. Cl. 56/14.7

(57) ABSTRACT

Apparatus for use in cutting vegetation comprises an arm, arm mounting means at one end of the arm for mounting the arm, for example to a tractor, and implement mounting means at the other end of the arm for mounting an implement for cutting vegetation. The arm is pivotted to be extendable horizontally in relation to the arm mounting means. The apparatus further includes determining means for determining the horizontal extent of the arm, and controlling means for controlling the downwards pressure at the said other end of the arm in accordance with the determined horizontal extent of the arm.

It is known to cut grass using a cutter head mounted on the end of an arm which is connected via a mounting to a tractor. The arm is extendable sideways in relation to the tractor. Thus, the tractor can drive along a road and grass beside the road can be cut in swathes at increasing distances from the road as the arm is extended for each new pass. The arm is pivoted centrally by one or more pivots and at the tractor. The arm is extended by the action of hydraulic rams on the arm under the control of the driver. The cutter head is supported by a roller and can roll along the ground. As the cutter head and arm are heavy, the cutter head will tend to sink into the ground and so it is known to exert an upwards force on the arm to reduce the effective weight at the cutting head. This is known as “float”. If this upwards force is a constant predetermined force, then, due to the cantilever effect, the weight exerted onto the ground through the cutter head will increase the further the head is from the tractor. This means that there is a risk of the cutting head digging in when the arm is extended and the cutting head is at its furthest extent from the tractor, whereas relatively low pressure will be exerted on to the ground when the cutting head is close to the tractor which may lead to uneven cutting.

In one known apparatus, a compensation chamber is provided in the hydraulic system for the hydraulic rams of the arm. The chamber contains an elastomeric bag containing a gas at high pressure, for example 6890 kPa (1000 psi), the bag being surrounded by hydraulic fluid in communication with the hydraulic system. Thus, when the hydraulic pressure is low, the bag will expand and conversely, when the hydraulic pressure is high, the bag will contract. In this way the cantilever effect can be compensated. However, this method is somewhat crude. The maximum degree of compensation depends on the size of the bag. Also, as the arm is extended the amount of compensation can drop undesirably.

According to the invention there is provided apparatus for use in cutting vegetation, the apparatus comprising an arm, arm mounting means at one end of the arm for mounting the arm, implement mounting means at the other end of the arm for mounting an implement for cutting vegetation, the arm being extendable horizontally in relation to the arm mounting means, the apparatus further including determining means for determining the horizontal extent of the arm, and controlling means for controlling the downwards pressure at the said other end of the arm in accordance with the determined horizontal extent of the arm.

In this way, the downwards pressure exerted through an implement, such as a grass cutter head, mounted on the arm can be controlled so that it is constant at whatever distance from the arm mounting means. The arm mounting means may, for example, mount the arm to a tractor. As the horizontal extent of the arm is determined, precise control of the downwards pressure at the other end of the arm can be effected.

The determining means can take any suitable form and preferably provides a digital signal to the controlling means for controlling downward pressure. The arm may extend in any suitable way, and, for example, may extend telescopically or by pivotting and preferably the arm pivots in relation to the arm mounting means as the arm is extended horizontally. The determining means for determining the horizontal extent of the arm may then be a pivot sensor and may comprise a potentiometer. The system does not only work in compensating the horizontal distance but also when the arm is extended upwards or downwards, for example on a sloping embankment.

The arm may be driven by any suitable drive means and may be driven hydraulically with the controlling means for controlling the downwards pressure at the other end of the arm controlling the hydraulic pressure.

Returning to the prior art, it is also known to cut hedges using a cutter head mounted on the end of the arm which is connected via a mounting to a tractor, the arm again extending sideways in relation to the tractor. The cutter head can be movable through a wide range of angles in order to be able to cut the sides and the top of a hedge and to cut overhanging vegetation from underneath.

British patent no. 2202122 in the name of the present applicant discloses an arm which is pivoted centrally and at the tractor and is extended by the action of hydraulic rams on the arm under the control of the driver. One hydraulic ram acts between the connection to the tractor's mounting and a first arm member of the arm. The first arm member forms a parallel linkage with a second arm member, and movement of the parallel linkage is under the control of a second ram. The last ram acts between the second arm member and an implement such as a hedge cutter head mounted at the end of the second arm member and controls the attitude of the implement. Two compensation rams are provided to ensure that the attitude of the hedge cutting implement remains constant in relation to the tractor mounting irrespective of operation of the hydraulic rams to lift and extend the arm to different positions.

In a preferred embodiment of the present invention, second controlling means is provided for controlling the implement mounting means to control the attitude of an implement mounted thereby so that the attitude remains constant irrespective of the position of the arm. In this way, the apparatus can be used both for grass cutting or cutting a hedge or the like, rather than using distinct dedicated systems or machinery for each task.

Preferably, at least one sensor is provided for sensing the position of the arm. The arm may pivot in relation to the mounting means and the or one sensor may be arranged to sense that. The arm may include two elongate arm members pivotally connected together and the or one sensor may be arranged to sense pivotting between the arm members. A sensor is also preferably provided for sensing the angle of the implement mounting means in relation to the arm.

The or each sensor preferably provides a digital signal to the second controlling means. Preferably the sensor sensing the angle of the implement mounting means has at least 240 steps, more preferably at least 480 steps. This affords sufficiently fine control.

In one embodiment, only three hydraulic rams are carried by the apparatus and the second controlling means controls the three rams. Thus, the two compensation rams of the known apparatus are omitted and replaced by a system of sensors passing signals to controlling means.

An embodiment of the invention will now be described by way of example and with reference to the accompanying drawings, of which:

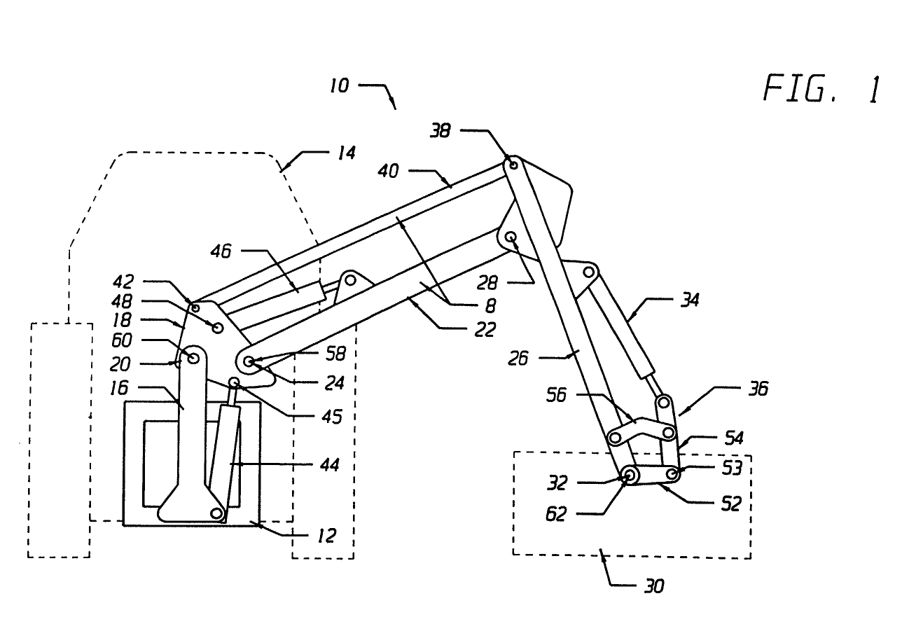

FIG. 1 is a rear elevation of the apparatus of the embodiment of the invention with a vehicle and cutter head shown in phantom; and

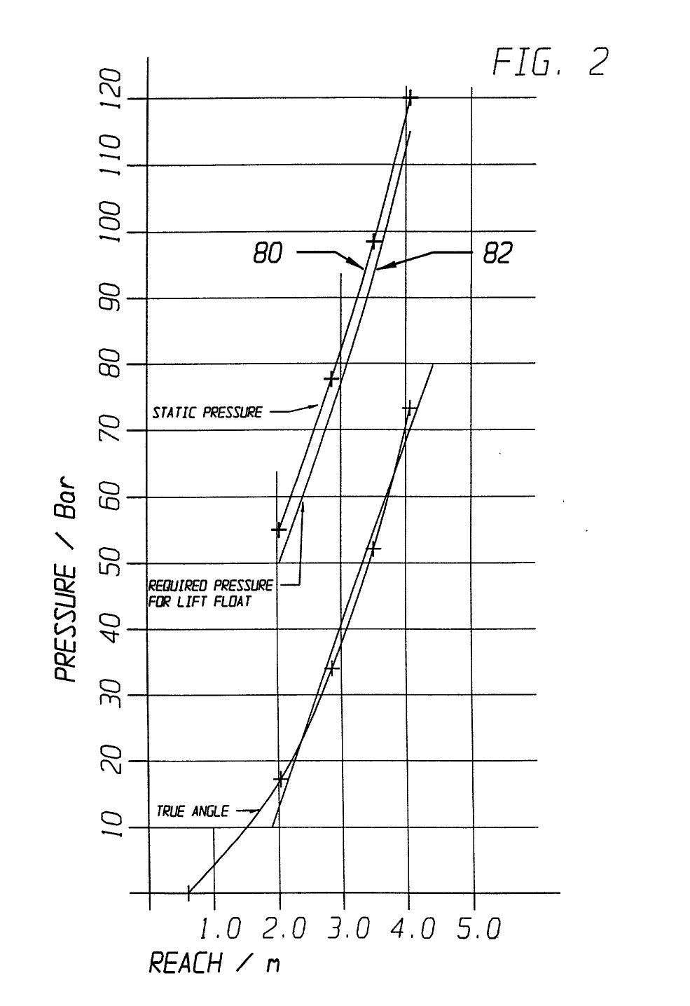

FIG. 2 is a graph showing pressure in a lift arm ram of the FIG. 1 apparatus for given values of reach.

The apparatus 10 comprises an arm 8 mounted on a support frame 12 in turn mounted upon a tractor 14 (shown in phantom). The rectangular support frame 12 includes a main upright support member 16. To the upper end of the support member 16 a carrier plate 18 is connected through a pivot joint 20. A first arm member 22, forming part of the arm 8, is pivotally connected at 24 to the carrier plate 18 through a pivot joint 24 which is laterally offset from the pivot joint 20. A second arm member 26 is pivotally connected through a pivot joint 28 to the opposite end of the first arm member 22.

An implement 30 in the form of a cutter head is pivotally mounted in the region of the free end of the arm member 26 on a shaft 32 for swinging movement relative to the arm member 26 under the control of an angling ram 34 which is connected at one end to the arm member 26 and at the other end to the implement by way of a linkage mechanism indicated generally at 36. The second arm member 26 extends in the opposite direction from the implement mounting shaft 32 past the pivot joint 28 for a short distance and its free end is connected through a pivot joint 38 to a third arm member 40, the opposite end of the third arm member 40 being connected to the upper part of the generally triangular carrier plate 18 through a pivot connection 42. The first and third arm members 22, 40 together with the portion of the second arm member 26 between the pivot joints 28, 38 and the carrier plate 18 form a parallel linkage.

A hydraulic ram 44 acts between the foot of the main support member 16 and a location 45 on the carrier plate 18 spaced laterally from the pivotal connection 20 between the main support member 16 and the carrier plate 18, such that extension or contraction of this ram 44 will cause the carrier plate 18 to move angularly about the pivotal connection 20 so as to raise and lower the arm 8, and with it the implement 30 relative to the tractor 14. A further hydraulic ram 46 is connected to the carrier plate 18 at a location 48 between the pivot joints 24, 42 and is connected at its opposite end to an intermediate point on the first arm member 22 so that extension and retraction of the hydraulic ram 46 will alter the angular position of the first arm member 22 in relation to the carrier plate 18. Because of the interconnection of the first, second and third arm members 22, 26, 40 and the carrier plate 18, in the form of a parallel linkage, the effect of such angular movement of the first arm member 22 will be to cause the arm 8 to move generally laterally of the tractor 14 and thereby extend the reach of the apparatus 10.

A simpler version without the carrier plate 18 and parallel arm 40 would also work if the ram 46 was connected between arms 8 and 26, and the pivot 24 was circulated with the pivot joint 20 and if the ram 44 connects to the arm 8.

The mechanism 36 includes a finger 52 fast for rotation with the shaft 32 and connected to the implement 30. The ram 34 is connected to the free end of the finger 52 by a slave link 54 which is pivotally connected at its respective ends to the end of the ram 34 and the end of the finger 52. The slave link 54 is connected in turn to the second arm member 26 by a radius arm 56 pivotally connected to the second arm member 26 and to the slave link 54. As is more fully described in British Patent No. 2192964 in the name of the present applicant, the aforesaid angling mechanism 36 enables the ram 34 to pivot the implement 9 through a substantial arc of 240° or more, whilst maintaining a more or less uniform speed of rotational movement of the implement 30.

Angular movement sensors 58, 60, 62 are provided at the pivot joints 24, 28 and 53. Each sensor takes the form of a potentiometer in combination with an analogue to digital converter. The digital signals from the sensors 58, 60, 62 are transmitted through lines (not shown) along the first and second arm members 22, 26 past the carrier plate 18 and into a microprocessor (not shown). On the basis of the digital signals received the microprocessor then sends control signals to the ram 34 to control the attitude of the implement 30.

Where the apparatus 10 is to be used for cutting grass, the apparatus 10 is manipulated by the driver controlling the rams 42, 46, 34 through the microprocessor to locate the grass cutting implement 30 on the ground at the desired distance from the tractor 14. The driver then initiates “float” operation. This disables the ram 34 so that the grass cutting implement 30 can pivot freely. Pressure is applied through the lifting ram 42, under control of the microprocessor, to reduce the downwards pressure on the ground exerted through the grass cutting implement 30 to avoid the implement 30 sinking into the ground, but is not reduced to such a level that the implement 30 leaves the ground over bumps or otherwise cuts unevenly. The effective weight at the cutting implement 30 may be reduced by two thirds to three quarters. The microprocessor operates according to an algorithm reflecting a graph of the horizontal extent or reach of the arm 8 in relation to the pressure in the lift ram 42 required to achieve the desired float pressure at the cutting implement 30. The sensor 58 at the pivot joint 24 provides complete information on the horizontal extent of the arm which enables the microprocessor to control the lift ram 44 to provide the appropriate downwards pressure at the grass cutting implement 30 acting solely on the digital signals received from that sensor 58.

FIG. 2 is a graph plotting pressure in the ram 42 for varying degrees of reach. It will be appreciated that reach can be calculated easily from the signals provided by the angular movement sensors 58, 60 and 62. Referring to FIG. 2, static pressure 80 is plotted in Bars (1 Bar=100 kPa) against reach. According to the invention, the lift pressure 82 is slightly less than the static pressure 80 over the possible range of reach, although the difference decreases slightly as reach increases. It will be appreciated by the person skilled in the art how to obtain a required ram pressure for given values of reach.

Where the apparatus 10 is to be used for cutting hedges or the like, the hedge cutting implement 30 will need to be supported in free space rather than used in float operation. The driver first manipulates the arm 8 to the correct position and then manipulates the implement 30 to the correct attitude using controls within the tractor 14 in the normal way. Once the arm 8 and implement 30 are in the correct position, information from the three sensors 58, 60, 62 is accepted by the microprocessor. When the reach or height of the arm 8 is altered, the microprocessor will control the ram 34 to ensure that the attitude of the hedge cutting implement 30 remains the same. It will be appreciated that information from all three sensors 58, 60, 62 is required to determine the attitude of the hedge cutting implement 30 in relation to the tractor mounting support frame 12.

In this way, grass cutting is afforded by an arrangement which is reliable and inexpensive to manufacture providing precise control of the pressure exerted on the ground at the cutting implement 30. Furthermore, the same apparatus 10 enables precise control of attitude of a hedge cutting implement 30 carried by the apparatus 10 in a compact, reliable and durable arrangement.

1. Apparatus for use in cutting vegetation, the apparatus comprising an arm, arm mounting means at one end of the arm for mounting the arm, implement mounting means at the other end of the arm for mounting an implement for cutting vegetation, the arm being extendable horizontally in relation to the arm mounting means, the apparatus further including determining means for determining the horizontal extent of the arm, and controlling means for controlling the downwards pressure at the said other end of the arm in accordance with the determined horizontal extent of the arm.

2. Apparatus as claimed in claim 1, in which the determining means provides a digital signal to the controlling means for controlling downward pressure.

3. Apparatus as claimed in claim 1 or claim 2, wherein the arm extends by pivotting.

4. Apparatus as claimed in claim 3, wherein the arm pivots in relation to the arm mounting means as the arm is extended horizontally.

5. Apparatus as claimed in claim 3 or claim 4, wherein the determining means for determining the horizontal extent of the arm is a pivot sensor.

6. Apparatus as claimed in claim 5, wherein the pivot sensor is a potentiometer.

7. Apparatus as claimed in any preceding claim, wherein the arm is driven hydraulically with the controlling means for controlling the downwards pressure at the other end of the arm controlling the hydraulic pressure.

8. Apparatus as claimed in any preceding claim, further comprising second controlling means for controlling the implement mounting means to control the attitude of an implement mounted thereby so that the attitude remains constant irrespective of the position of the arm.

9. Apparatus as claimed in claimed in claim 8, wherein at least one sensor is provided for sensing the position of the arm.

10. Apparatus as claimed in claim 9, wherein the arm is arranged to pivot in relation to the mounting means, and the or one sensor is arranged to sense the pivotting in relation to the mounting means.

11. Apparatus as claimed in claim 9 or claim 10, wherein the arm includes two elongate arm members pivotally connected together and the or one sensor is arranged to sense pivotting between the arm members.

12. Apparatus as claimed in any of claims 8 to 11, wherein a sensor is provided for sensing the angle of the implement mounting means in relation to the arm.

13. Apparatus as claimed in any of claims 9 to 12, wherein the or each sensor provides a digital signal to the second controlling means.

14. Apparatus as claimed in claim 13 when dependent on claim 12, wherein the sensor sensing the angle of the implement mounting means in relation to the arm has at least 240 steps.

15. Apparatus as claimed in claim 14, wherein the sensor sensing the angle of the implement mounting means in relation to the arm has at least 480 steps.

16. Apparatus as claimed in any of claims 8 to 15, wherein only three hydraulic rams are carried by the apparatus and the second controlling means controls the three rams.

17. Apparatus for use in cutting vegetation, the apparatus being substantially as herein described with reference to and/or as shown in FIG. 1 or FIGS. 1 and 2 of the accompanying drawings.
